(19) United States
(12) Patent Application Publication
(10) Pub. No.: US 2020/0150947 A1
(43) Pub. Date: May 14, 2020

(54) INFORMATION PROCESSING APPARATUS, UPDATING METHOD BY INFORMATION PROCESSING APPARATUS, AND RECORDING MEDIUM

(71) Applicant: Yusuke HAYASHI, Kanagawa (JP)

(72) Inventor: Yusuke HAYASHI, Kanagawa (JP)

(73) Assignee: Ricoh Company, Ltd., Tokyo (JP)

(21) Appl. No.: 16/590,493

(22) Filed: Oct. 2, 2019

(30) Foreign Application Priority Data
Nov. 14, 2018 (JP) 2018-213984

(51) Int. Cl. G06F 8/65; G06F 8/61; H04N 1/00; G06F 8/71

(52) U.S. Cl. CPC G06F 8/65; G06F 8/71; H04N 1/00938; G06F 8/61

(57) ABSTRACT

An information processing apparatus includes processing circuitry; and a memory storing computer-executable instructions that cause the processing circuitry to: store, in a storage, an application file used for installing an application to the information processing apparatus; update the application file stored in the storage; install the application to the information processing apparatus by using the application file; determine whether an old version of an update target application file is stored in the storage; and determine whether an old version of an update target application is installed. The update target application file stored in the storage is updated and installation of the update target application using the update target application file is prevented, upon determining that the old version of the update target application file is stored in the storage and determining that the old version of the update target application is not installed.

### CROSS-REFERENCE TO RELATED APPLICATION

The present application is based on and claims priority under 35 U.S.C. § 119 to Japanese Patent Application No. 2018-213984, filed on Nov. 14, 2018, the contents of which are incorporated herein by reference in their entirety.

### BACKGROUND OF THE INVENTION

### 1. Field of the Invention

The present invention relates to an information processing apparatus, an updating method by the information processing apparatus, and a recording medium.

### 2. Description of the Related Art

In the related art, an application installed in an information processing apparatus is updated or reinstalled, by inputting the latest version of a group of files, such as program files or data files, relating to the application (hereinafter referred to as an “application file”), into the apparatus from outside the apparatus.

Patent Document 1 describes a method for updating an application program stored in a flash memory, in an electronic device equipped with a flash memory.
Patent Document 1: Japanese Unexamined Patent Application Publication No. 2011-164827

### SUMMARY OF THE INVENTION

According to one aspect of the present invention, there is provided an information processing apparatus including processing circuitry; and a memory storing computer-executable instructions that cause the processing circuitry to store, in a storage, an application file used for installing an application to the information processing apparatus; update the application file stored in the storage; install the application to the information processing apparatus by using the application file; determine whether an old version of an update target application file is stored in the storage; and determine whether an old version of an update target application is installed, wherein the update target application file stored in the storage is updated and installation of the update target application using the update target application file is prevented, upon determining that the old version of the update target application file is stored in the storage and determining that the old version of the update target application is not installed.

### BRIEF DESCRIPTION OF THE DRAWINGS

FIG. 1 is a functional block diagram of an information processing apparatus according to an embodiment of the present invention;

FIG. 2 is a diagram illustrating a hardware configuration of the information processing apparatus according to an embodiment of the present invention;

FIG. 3 is a flow chart of an updating process performed by the information processing apparatus according to an embodiment of the present invention;

FIG. 4 is a diagram illustrating an example configuration of the information processing apparatus before performing the updating process according to an embodiment of the present invention;

FIG. 5 is a diagram illustrating an example of the configuration of the information processing apparatus after performing the updating process according to an embodiment of the present invention; and

FIG. 6 is a diagram illustrating a comparison example of a configuration of an information processing apparatus of the related art after performing update processing with the configuration of FIG. 4.

### DETAILED DESCRIPTION OF THE PREFERRED EMBODIMENTS

In an information processing apparatus, there are cases where the above-described “application file” is stored in an internal storage inside the apparatus, without installing the application. In this case, by the method of updating an application of the related art, even if the latest version of the application file is input into the apparatus, it is not possible to update the application file stored inside the information processing apparatus. Further, in this case, even when it is not desired to install an application relating to the application file, in the application updating method of the related art, when the latest version of the application file is input into the apparatus, the application will be installed.

A problem to be addressed by an embodiment of the present invention is to enable the updating of an application file that is stored inside the apparatus, but not installed, and to prevent the needless installation of an application based on the application file.

Hereinafter, embodiments will be described with reference to the accompanying drawings. In order to facilitate the understanding of the description, the same elements in the drawings are denoted by the same reference numerals as much as possible, and overlapping descriptions are omitted.

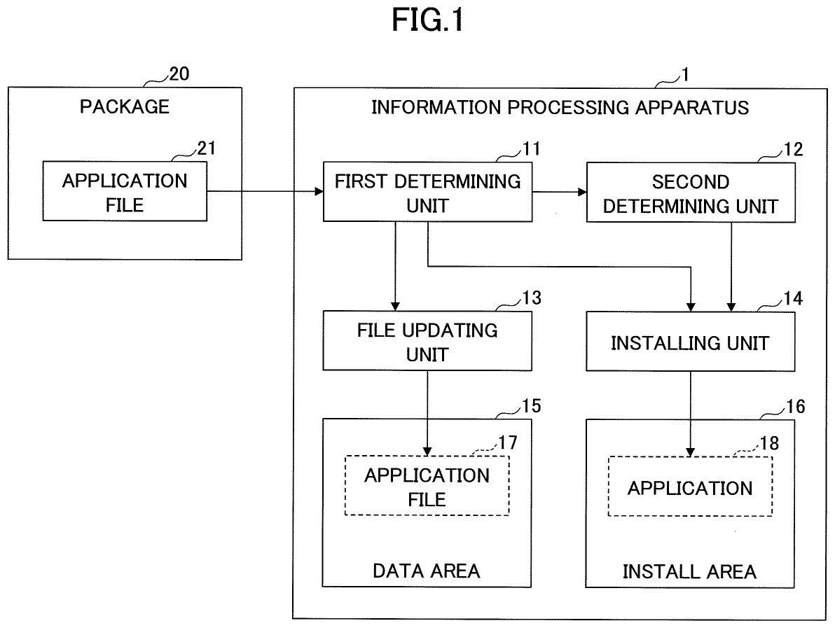

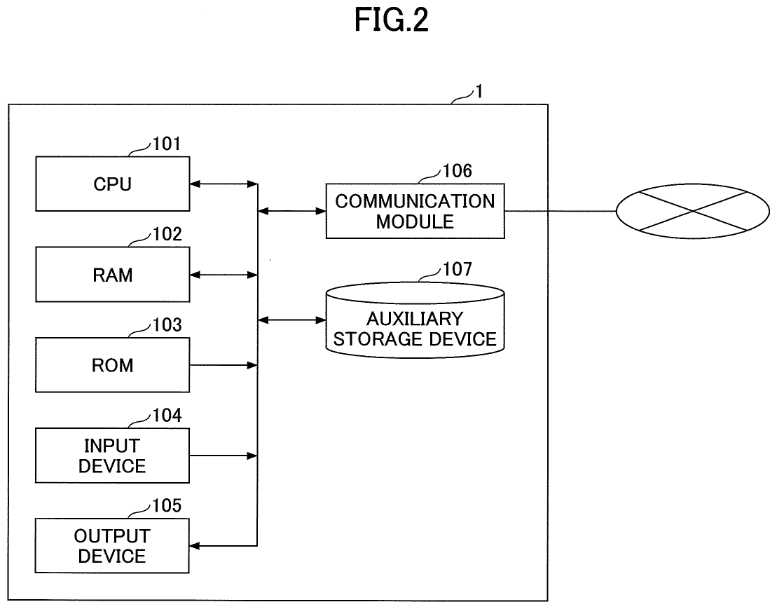

Referring to FIGS. 1 to 2, a configuration of an information processing apparatus 1 according to an embodiment will be described. FIG. 1 is a functional block diagram illustrating the information processing apparatus 1 according to an embodiment.

The information processing apparatus 1 illustrated in FIG. 1 causes an application 18 installed in the information processing apparatus 1 to operate, thereby performing a function relating to the application 18. Further, the information processing apparatus 1 can store an application file 17 in the apparatus without installing the application file. Here, the application file 17 of the present embodiment means a group of files such as program files or data files relating to an application that can be installed in an information processing apparatus. For example, the user of the information processing apparatus 1 can install an application by using the application file 17 stored in the apparatus in advance, at any time when the user desires to use the desired application 18.

In the information processing apparatus 1, a package 20 including an application file 21 that is the latest version can be input, so as to update the application 18 (update target application) in the apparatus, based on the application file 21 that is the latest version, or to newly install the application 18 in the apparatus. Further, in the information processing apparatus 1, the package 20 can be input so as to update the application file 17 (update target application file) stored in the apparatus.

The meaning of the term “install” as used in the present embodiment includes “clean installation” for installing an entirely new application that is not present in the apparatus; and “update installation” for installing a new version of the application that has already been installed in the apparatus, to overwrite and update the old version of the application that is already installed.

As functions related to the above, the information processing apparatus 1 includes a first determining unit 11, a second determining unit 12, a file updating unit 13, an installing unit 14, a data area 15 (storage unit), and an install area 16.

The data area 15 stores the application file 17 used for installation of the application 18. The application file 17 is stored inside the information processing apparatus 1, but is not installed. The application file 17 can be installed at any time by a user or a maintenance administrator.

The install area 16 stores the application 18 installed in the information processing apparatus 1.

The file updating unit 13 updates the application file 17 stored in the data area 15.

The installing unit 14 installs the application 18 in the information processing apparatus 1 by using the application file 17 stored in the data area 15 or the application file 21 included in the package 20.

When the application 18 (update target application) in the information processing apparatus 1 is updated by using the application file 21 (update target application file) in the package 20, the first determining unit 11 determines whether the application file 17 that is the old version is stored in the data area 15.

Similarly, when the application 18 (update target application) in the information processing apparatus 1 is updated by using the application file 21 (update target application file) in the package 20, the second determining unit 12 determines whether the application 18 of the old version has been installed.

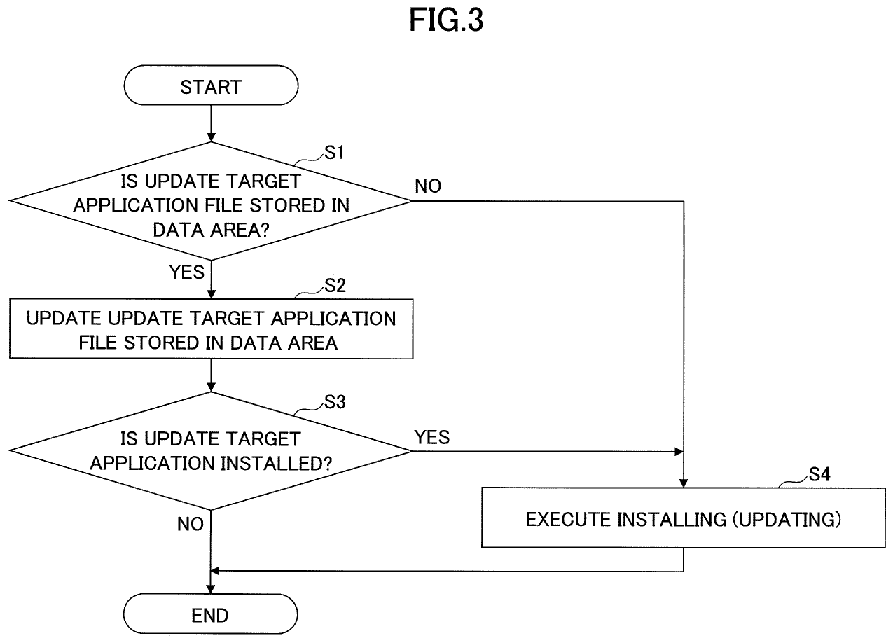

The file updating unit 13 and the installing unit 14 determine whether to update the application file 17 in the apparatus based on the application file 21 in the package 20, or to install the application 18, according to the determination results of the first determining unit 11 and the second determining unit 12. Details will be described later with reference to FIGS. 3 to 5.

FIG. 2 is a block diagram illustrating a hardware configuration of the information processing apparatus 1. As illustrated in FIG. 2, the information processing apparatus 1 can be configured as a computer system including, physically, a Central Processing Unit (CPU) 101, a Random Access Memory (RAM) 102 that is a main storage device, a Read-Only Memory (ROM) 103, an input device 104 such as a keyboard and a mouse that are input devices, an output device 105 such as a display, a communication module 106 that is a data transmission and reception device such as a network card, and an auxiliary storage device 107 such as a hard disk.

Each function of the information processing apparatus 1 illustrated in FIG. 1 is implemented by loading predetermined computer software (update program) in the hardware such as the CPU 101 and the RAM 102, thereby causing the communication module 106, the input device 104, and the output device 105 to operate under the control of the CPU 101, and reading and writing data in the RAM 102 or the auxiliary storage device 107. That is, by executing the update program according to the present embodiment on a computer, the information processing apparatus 1 functions as the first determining unit 11, the second determining unit 12, the file updating unit 13, and the installing unit 14 of FIG. 1. The data area 15 and the install area 16 illustrated in FIG. 1 can be implemented by a part of the storage device (such as the RAM 102, the ROM 103, and the auxiliary storage device 107) provided in the computer.

The package 20 illustrated in FIG. 1 may be a portable storage medium such as a Compact Disk Read-Only Memory (CD-ROM), a digital versatile disk (DVD)-ROM, and a flash memory. When a storage medium of any of the aforementioned types is readably connected to the information processing apparatus 1, the updating of the application file 17 and the application 18 in the information processing apparatus 1 is executed by using the application file 21 that is the latest version stored in the package 20. The package 20 may be configured to be transmitted via a transmission medium, such as a communication line, and received by the communication module 106 or the like provided in the computer, and the updating process may be executed after the package 20 is received.

Referring to FIG. 3, an update method of the information processing apparatus 1 according to the embodiment will be described. FIG. 3 is a flowchart of the updating process of the information processing apparatus 1. When the package 20 is connected as illustrated in FIG. 1, and the application file 21 that is the latest version included in the package 20, can be input to the information processing apparatus 1, the information processing apparatus 1 performs the updating process of FIG. 3. In the following description, an application that can be updated by the application file 21 is also referred to as an “update target application”. Further, an application file, among the application files 17 stored in the data area 15, that is of the same type as the application file 21 in the package 20, is also referred to as an “update target application file”.

In step S1, the first determining unit 11 determines whether the application file (update target application file) relating to the update target application is stored in the data area 15 (first determining step). The first determining unit 11 can determine whether the update target application file is stored in the data area 15 based on information such as the name of the application file 21 in the package 20.

When it is determined in step S1 that the update target application file is not stored in the data area 15 (NO in step S1), the process advances to step S4.

On the other hand, when it is determined in step S1 that the update target application file is stored in the data area 15 (YES in step S1), the process proceeds to step S2, and the file updating unit 13 overwrites and updates the update target application file stored in the data area 15, with the application file 21 in the package 20 (file updating step), and the process proceeds to step S3.

In step S3, the second determining unit 12 determines whether the update target application is installed in the information processing apparatus 1 (second determining step). For example, the second determining unit 12 can obtain information of an installed application from the operating system (OS) of the information processing apparatus 1 and determine whether the update target application is installed based on the obtained information and the application name. When the update target application is installed (YES in step S3), the process proceeds to step S4. When the update target application is not installed (NO in step S3), this control flow is ended without executing the installation (file updating step).

In step S4, it has been determined in step S1 that the update target application file is not stored in the data area 15, or it has been determined in step S3 that the update target application is installed, and, therefore, the installing unit 14 executes the installation (updating) of the update target application in the install area 16 of the information processing apparatus 1, by using the application file 21 in the package 20. When the process in step S4 is completed, this control flow ends.

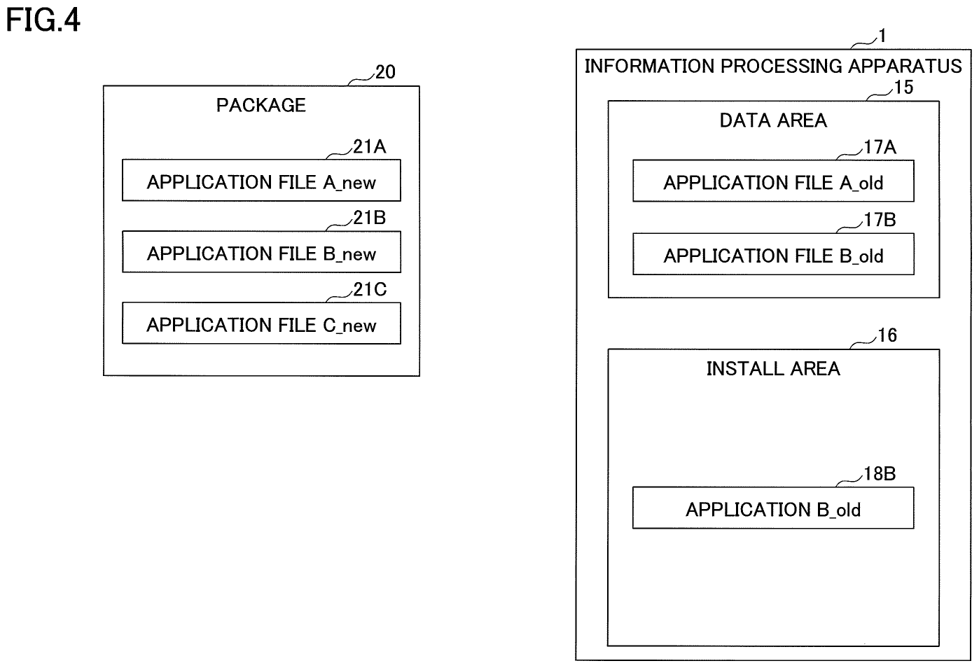

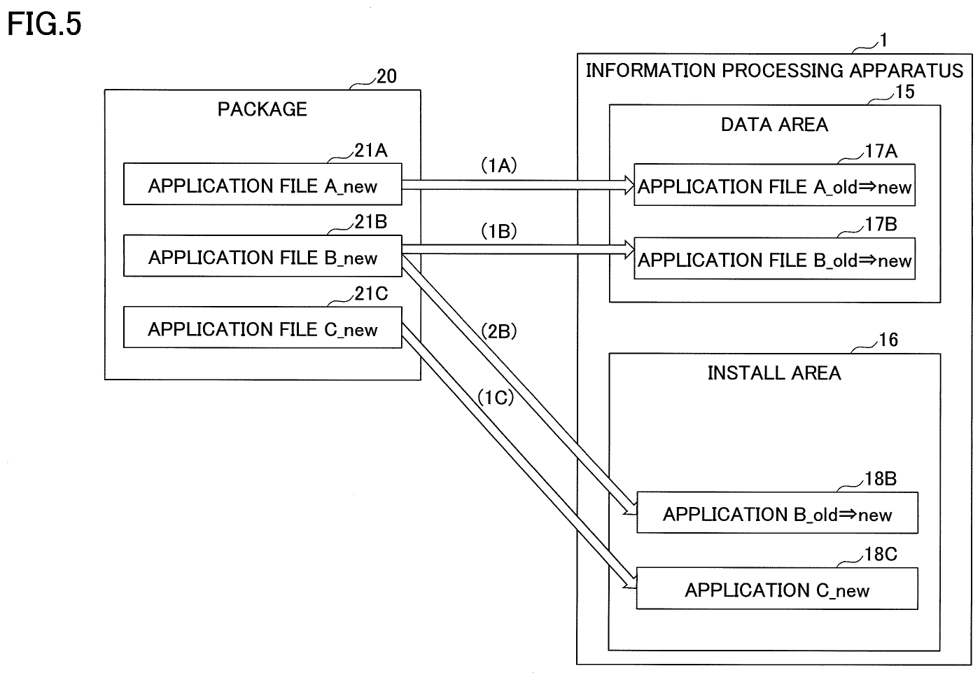

Referring to FIGS. 4 to 6, the updating process will be further described. FIG. 4 is a diagram illustrating an example of the configuration of the information processing apparatus 1 before performing the updating process of the embodiment. FIG. 5 is a diagram illustrating an example of the configuration of the information processing apparatus 1 after performing the updating process of the embodiment.

As illustrated in FIG. 4, latest versions 21A, 21B, and 21C (indicated as “_new” in the figure) of the three types of application files A, B, and C, respectively, are stored in the package 20. As illustrated in FIG. 4, before performing the updating process, the old versions 17A and 17B (indicated as “_old” in the figure) of application files A and B, respectively are stored in the data area 15 of the information processing apparatus 1; and an old version 18B of an application B is stored in the install area 16 of the information processing apparatus 1. That is, in the example of FIG. 4, three kinds of applications A, B, and C having different storage states in the information processing apparatus 1 are illustrated.

When the updating process is performed by using the package 20 in the configuration illustrated in FIG. 4, the configuration of the information processing apparatus 1 is finally changed to the state illustrated in FIG. 5.

With respect to the application A, in the state before the updating process as illustrated in FIG. 4, the application file is stored in the data area 15, but the application A is not installed. Therefore, in the flowchart of FIG. 3, the process proceeds as step S1 (YES)→step S2→3 step S3 (NO), and processing based on the determination result of the first determining unit 11 ((1A) in FIG. 5) is performed, but processing based on the determination result of the second determining unit 12 is not performed. As a result, after the updating process, that is the state illustrated in FIG. 5, the application file A in the data area 15 is overwritten and updated by the application file 21A that is the latest version, but the application A is not installed.

Therefore, in the case of the storage state of the application A as illustrated in FIG. 4, by update processing according to the present embodiment, only the application file can be updated without installing the application, and, therefore, it is possible to update an application file that is stored in the information processing apparatus 1 but that is not installed, so that it is possible to prevent the needless installation of an application based on the application file.

With respect to application B, in the state before the updating process as illustrated in FIG. 4, the application file is stored in the data area 15 and the application B installed. Therefore, in the flowchart of FIG. 3, the process proceeds as step S1 (YES)→step S2→step S3 (YES)→step S4, and processing based on the determination result of the first determining unit 11 ((1B) in FIG. 5) is performed, and processing based on the determination result of the second determining unit 12 ((2B) in FIG. 5) is performed. As a result, in the state after the updating process as illustrated in FIG. 5, the application file B in the data area 15 is overwritten and updated by the application file 21B that is the latest version, and the application B is updated by using the application file 21B.

Therefore, in the case of the storage state of the application B illustrated in FIG. 4, by the updating process according to the present embodiment, the application file that is stored in the internal storage but that is not installed, can be updated, and the application can also be updated based on the application file.

With respect to application C, in the state before the updating process as illustrated in FIG. 4, the application file is not stored in the data area 15 and the application C is not installed. Accordingly, in the flowchart of FIG. 3, the process proceeds as step S1 (NO)→step S4, and processing based on the determination result of the first determining unit 11 ((1C) in FIG. 5) is performed, but the second determining unit 12 does not perform any determination. As a result, in the state after the updating process as illustrated in FIG. 5, the application file C is not stored in the data area 15, and the application C is newly installed by using the application file 21C.

Therefore, in the case of the storage state of the application C as illustrated in FIG. 4, by the updating process according to the present embodiment, it is possible to install an application based on the latest application file, without storing the application file.

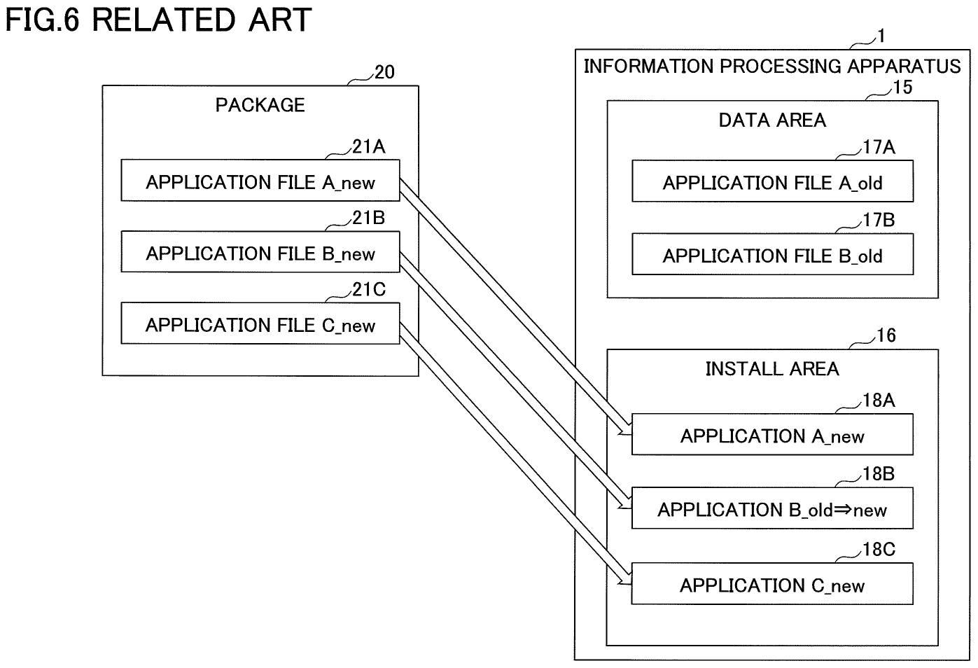

FIG. 6 is a diagram illustrating a comparison example of the configuration of the information processing apparatus after performing an update processing of the related art with the configuration of FIG. 4. In the updating process of the related art, the flowchart illustrated in FIG. 3 is not executed, but all applications are installed at the same time by using the application files in the package 20.

The applications A and C are not installed in the install area 16 in the state before the updating process as illustrated in FIG. 4, and, therefore, by the updating process of the related art, the installation is performed by using the latest application files 21A and 21C in the package 20, and the applications A and C of the latest versions are installed, as illustrated in FIG. 6.

With respect to the application B, in the state before the updating process as illustrated in FIG. 4, the application B of the old version is installed in the install area 16, and, therefore, by the updating process of the related art, installation is performed by using the application file 21B that is the latest version in the package 20, and the application B is updated to the latest version, as illustrated in FIG. 6.

In contrast, by the updating process of the related art, in the data area 15, no updating is performed with the use of the package 20, and, therefore, the applications files A and B of the old versions still remain even after the updating process, as illustrated in FIG. 6. That is, an unnecessary application A is installed, and the application files A and B cannot be updated. Further, the application file in the data area 15 and the application in the install area 16 are of different versions.

In the present embodiment, as described with reference to FIG. 5, the situation as illustrated in FIG. 6 will not occur, and it is possible to prevent needless installation of the application A. Further, the application file can be updated, and, therefore, the application file in the data area 15 and the application in the install area 16 will be of the same version after the updating process.

The updating process can also be expressed as follows. In the updating process in which applications in the information processing apparatus 1 are collectively updated with the package 20, it is confirmed whether the application file relating to the application that is the update target is stored in the data area 15, and when it is confirmed that the application file is stored, the application file 17 in the data area 15 is updated. Further, when the application that is the update target is installed in the install area 16, the application is updated.

With this configuration, it is possible to update an application file that is stored in the apparatus but that is not installed, and it is possible to prevent needless installation of an application based on the application file. Accordingly, the application file 17 that is stored inside the apparatus but is not installed in the apparatus, is always maintained in the latest state, and can be installed according to need, and, therefore, the operations by the user or a maintenance administrator of the information processing apparatus 1 can be simplified, and the convenience is improved.

Further, by this configuration, the application file 17 in the apparatus can be freely updated, and, therefore, the application can be released without being installed at the time of factory shipment, but with the application file being saved in the apparatus. This makes it possible to install an application according to need without an external storage medium, thus improving convenience.

As described above, the present embodiment has been described with reference to the specific examples. However, the present disclosure is not limited to these embodiments. Examples obtained by appropriately making design modifications to the specific examples by those skilled in the art, are also encompassed by the present disclosure as long as the features of the present disclosure are included. The elements provided in each of the embodiments described above, and the arrangement, conditions, shape, and the like thereof, may be appropriately modified without being limited to those exemplified. Each element provided by each of the above-described embodiments may vary in combination as appropriate, unless there is a technical inconsistency.

In the above-described embodiment, the general computer system illustrated in FIG. 2 is exemplified as the information processing apparatus 1. However, embodiments of the present invention can be applied to devices specializing in a specific function, such as, for example, a multifunction peripheral having image processing functions such as functions of a facsimile machine, a scanner, a copy, or a printer, or communication functions; or an image forming apparatus including a main body unit and an operation unit which can be operated by different CPUs.

According to one embodiment of the present invention, it is possible to update an application file stored that is inside an apparatus, but not installed, and to prevent needless installation of an application based on the application file.

The information processing apparatus, the updating method by the information processing apparatus, and the recording medium are not limited to the specific embodiments described in the detailed description, and variations and modifications may be made without departing from the spirit and scope of the present invention.

What is claimed is:

1. An information processing apparatus comprising:
processing circuitry; and
a memory storing computer-executable instructions that cause the processing circuitry to:
store, in a storage, an application file used for installing an application to the information processing apparatus;
update the application file stored in the storage;
install the application to the information processing apparatus by using the application file;
determine whether an old version of an update target application file is stored in the storage; and
determine whether an old version of an update target application is installed, wherein
the update target application file stored in the storage is updated and installation of the update target application using the update target application file is prevented, upon determining that the old version of the update target application file is stored in the storage and determining that the old version of the update target application is not installed.

2. The information processing apparatus according to claim 1, wherein the update target application file stored in the storage is updated and the update target application is installed by using the update target application file, upon determining that the old version of the update target application file is stored in the storage and determining that the old version of the update target application is installed.

3. The information processing apparatus according to claim 1, wherein the update target application is installed by using the update target application file, upon determining that the old version of the update target application file is not stored in the storage.

4. An updating method performed by an information processing apparatus, the updating method comprising:
determining whether an old version of an update target application file is stored in a storage, the storage being configured to store an application file used for installing an application to the information processing apparatus;
determining whether an old version of an update target application is installed to the information processing apparatus; and
updating the update target application file stored in the storage and preventing installation of the update target application using the update target application file, upon determining that the old version of the update target application file is stored in the storage and determining that the old version of the update target application is not installed.

5. A non-transitory computer-readable recording medium storing a program that causes a computer to execute a process performed in a an information processing apparatus, the process comprising:
determining whether an old version of an update target application file is stored in a storage, the storage being configured to store an application file used for installing an application to the information processing apparatus;
determining whether an old version of an update target application is installed to the information processing apparatus; and
updating the update target application file stored in the storage and preventing installation of the update target application using the update target application file, upon determining that the old version of the update target application file is stored in the storage and determining that the old version of the update target application is not installed.
